(19) United States
(12) Patent Application Publication
(10) Pub. No.: US 2013/0298215 A1
(43) Pub. Date: Nov. 7, 2013

(54) SINGLE SIGN-ON USER REGISTRATION FOR ONLINE OR CLIENT ACCOUNT SERVICES

(71) Applicants: Vsevolod Kuznetsov, Sankt-Petersburg (RU); Nicholas Pushkin, Sankt-Petersburg (RU)

(72) Inventors: Vsevolod Kuznetsov, Sankt-Petersburg (RU); Nicholas Pushkin, Sankt-Petersburg (RU)

(73) Assignee: RAWLLIN INTERNATIONAL INC.

(21) Appl. No.: 13/464,465

(22) Filed: May 4, 2012

(51) Int. Cl. H04L 9/32; G06F 21/00

(52) U.S. Cl. 726/8

(57) ABSTRACT

Providing for single sign on (SSO) registration for local or network applications in conjunction with a multimedia display device is described herein. By way of example, SSO registration can comprise creating a registration account and linking one or more local or network applications with the registration account. SSO registration can facilitate auto-filling user data requests submitted by registration servers associated with the applications, in conjunction with registering a user for content or services provided by the respective applications. User verification, where requested, can be facilitated by digital certificate or other secure communication. Once registration is completed, a user can access content provided by an application by activating a linked application at the multimedia display device, or a remote device.

### TECHNICAL FIELD

The subject disclosure relates generally to online multimedia content services, and more particularly toward providing single sign-on user registration functionality for network or local application services.

### BACKGROUND

The advent of the Internet and widespread consumer access to network-stored multimedia content has greatly expanded the scope and availability of electronic communication and electronic content services. For instance, fixed electronic communication systems have become a backbone of industrial, commercial and personal communications worldwide. Likewise, mobile communication networks have provided voice and data communication functionality that have become near-ubiquitous for both business and personal communications throughout much of the world. Content-related communication, for audio/video entertainment, single player and multiplayer online games, and the like, has also become popular, utilizing the fundamental architecture of the Internet and associated webs or networks as the underlying data/content communication platform.

Content and service providers generally employ electronic processing equipment, such as sets of multi-access servers, to communicate with and identify client devices, handle client communication or content requests, provide encryption or other security, and to track usage for billing and charging purposes. Additionally, content and service providers maintain integrated large capacity data storage in conjunction with the multi-access servers, to store content and other services. Upon authorizing a client device to access a subset of content, service provider equipment can facilitate delivering subsets of stored content to users, on request. This framework enables content providers to charge for content services through a subscription account, or the like. Common modern examples of online content or services include multimedia content such as movies, episode-based television content such as sitcoms, news programs, and other audio/video content, as well as audio content, and even real time interactive audio/video content, single-player or multi-player games, as well as communication services, blogs, online forums, e-mail, text messaging, multimedia messaging, and so on.

Different content/service providers generally provide subscription-based access to their content/services. Some providers offer a single service, such as mobile voice communication, or online multiplayer gaming, whereas other providers a range of services. Generally though, a particular user might be interested in a range of content/services provided by multiple service providers. This often results in the user obtaining and maintaining a set of subscription accounts to receive the content or services. An example could include a user having a first online account for online multimedia television content, a second account for mobile phone services, and a third account for a web-based e-mail services, for instance.

Online television content has become an increasingly popular application for online multimedia content/services. Network television services typically involve delivering audio and video content over a network connection (e.g., an Internet connection, an intranet connection, . . . ) to a multimedia playback device, such as a television. In turn, the playback device is configured to communicate via its own network connection, and receive and play multimedia content. Network television services provide several advantages over traditional broadcast or cable television services. First, network television content can generally be stored persistently on a network data store, and accessed through a multi-access server. This facilitates access and consumption of stored content concurrently by multiple client devices (e.g., network-enabled television, personal computer, laptop computer, smart phone, tablet computer, . . . ) at their own initiation; a provider of the network television content is not required to initiate a broadcast to an unknown number of client devices which might be tuned in to the broadcast. This results in a far greater degree of consumer-directed control over content with far fewer independent dedicated channels (and radio/cable bandwidth) than are typically required for broadcast television services. Second, network television content can leverage existing network communication pathways, in effect reducing the overall infrastructure equipment associated with delivering television services, radio services, or other multimedia content services, and general network data services (e.g., web browsing, online shopping, . . . ) to consumers. Third, by leveraging public networks, like the Internet, and existing access infrastructure for those networks, a more direct connection between service provider and consumer is possible, with relatively direct client-server communication between the consumer and service provider. The result is more responsive, efficient and cost effective content delivery, benefiting both the service provider and consumer.

Because network multimedia content is managed via client-server communications over a network, client authorization and user verification procedures are employed to control client access to content. A server might, for instance, be provisioned to check that a client device is associated with a subscription account offered by a particular content provider. This allows a service provider to limit content delivery only to those users who have an agreement with the service provider, as well as protect intellectual property rights of content owners. As technology associated with consumer playback devices, and network access infrastructure change, providers typically adapt their services to achieve new possibilities made available by these technological changes. This evolution in technology is ongoing, and generates seemingly perpetual demand to expand upon or improve existing content or services to match these changes, and is one of many current challenges related to online multimedia content delivery.

### SUMMARY

The following description and the annexed drawings set forth in detail certain illustrative aspects of the disclosed subject matter. These aspects are indicative, however, of but a few of the various ways, or embodiments, in which the principles of the disclosed subject matter may be implemented. The disclosed subject matter is intended to include all such embodiments and their equivalents. Other advantages and distinctive features of the disclosed subject matter will become apparent from the following detailed description of the various embodiments when considered in conjunction with the drawings.

The subject disclosure provides for single sign on (SSO) registration for local or network applications in conjunction with a multimedia display device. SSO registration can comprise creating a registration account and linking one or more local or network applications with the registration account. Creating the registration account can include providing user information to facilitate auto-filling user data associated with registering a user for the respective applications. Once registration is completed, a user can access content provided by an application by activating a linked application at the multimedia display device, or a remote device.

In particular aspects of the subject disclosure, creating a registration account for SSO registration can include establishing remote access to content provided by a successfully registered application. Remote access can be provided for a computer, a laptop, a mobile device, a tablet computer, and so on. Remote access can include specifying an authorized communication channel for the remote access, such as an e-mail account, a mobile phone communication, a network communication access, or the like. In addition, remote access can include a user or device verification in which identifying information particular to a communication device can be provided as part of establishing the remote access, and in which remote access attempts can be conditioned upon submitting the identifying information.

SSO registration as described herein, can significantly reduce overhead time involved in registering a user of a multimedia display device for a set of network or local client applications. Additionally, the SSO registration can facilitate access to application content or services via applications operating on the display device, or a remote device. Accordingly, SSO registration provides significant benefits for users of a multimedia display device, such as a network-enabled television.

The following description and the annexed drawings set forth in detail certain illustrative aspects of the disclosed subject matter. These aspects are indicative, however, of but a few of the various ways in which the principles of the disclosed subject matter can be employed and the disclosed subject matter is intended to include all such aspects and their equivalents. Other advantages and novel features of the disclosed subject matter will become apparent from the following detailed description when considered in conjunction with the drawings.

### BRIEF DESCRIPTION OF THE DRAWINGS

FIG. 1 illustrates a block diagram of an example media playback device according to one or more aspects of the subject disclosure.

FIG. 2 illustrates a diagram of a sample system for providing single sign on (SSO) registration for local or network applications at a display device.

FIG. 3 depicts a diagram of a sample system for providing remote access to application content or services in conjunction with SSO registration.

FIG. 4 illustrates a block diagram of an example client-server communication system for providing SSO registration according to some aspects.

FIG. 5 depicts a block diagram of a sample network-enabled television providing automated access to application content in other disclosed aspects.

FIG. 6 depicts a block diagram of an example system for providing third-party authorization in conjunction with SSO registration according to some aspects.

FIG. 7 illustrates a block diagram of an example display device that facilitates SSO registration user certification with a removable storage device.

FIG. 8 depicts a flowchart of a sample method for providing SSO registration with a multimedia display device according to further disclosed aspects.

FIGS. 9 and 10 depict a flowchart of an example method for providing SSO registration to a set of network or local applications according to particular aspects.

FIG. 11 depicts a flowchart of a sample method for remote access to application content in conjunction with SSO registration according to further aspects.

FIG. 12 illustrates a block diagram of an example electronic computing environment that can be implemented in conjunction with one or more aspects.

FIG. 13 depicts a block diagram of an example data communication network that can be operable in conjunction with various aspects described herein.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing the subject innovation.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

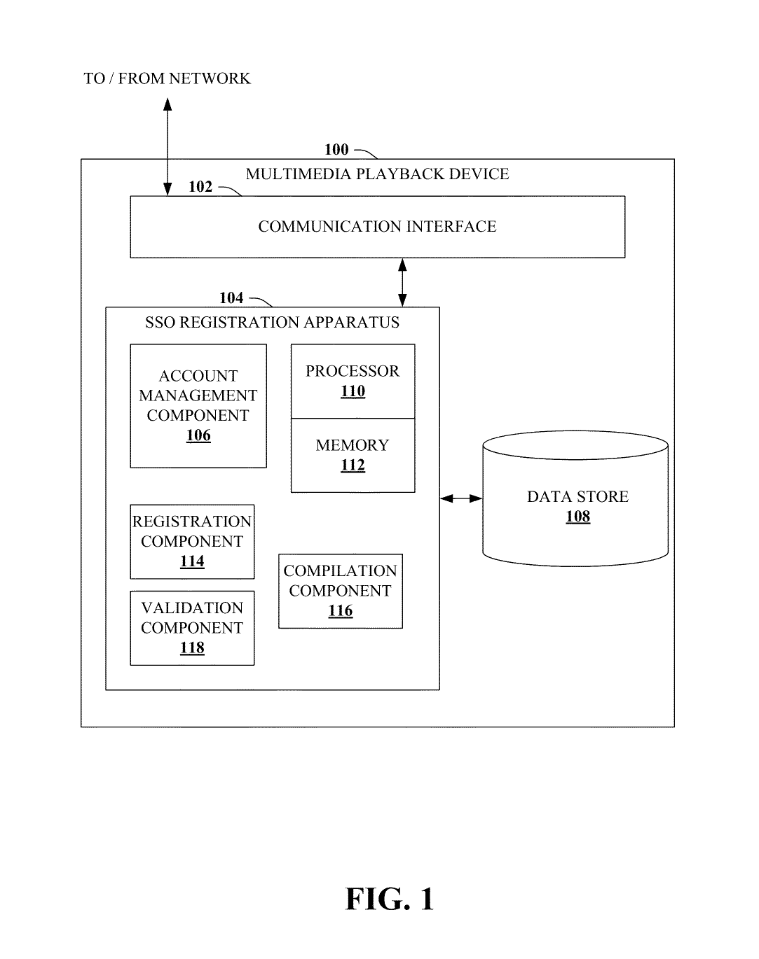

FIG. 1 illustrates a block diagram of an example multimedia playback device 100 according to one or more aspects of the subject disclosure. Multimedia playback device 100 can include various devices configured at least for playing audio-video content and for communicating with a network. As a particular example, multimedia playback device 100 can include a network-enabled television device, tablet computer, computer, laptop, mobile device, and so on.

Multimedia playback device 100 can comprise a communication interface 102 to an electronic communication network. Communication interface 102 can include, for instance, a modem, a network interface, a router, and so on. Generally, communication interface 102 can be configured to facilitate data communication between multimedia playback device 100 and local network devices, such as a computer connected over a local area network, wide area network devices, such as a computer terminal connected to a wide area intranet, or to the Internet or associated inter-connected networks. Communication interface 102 can comprise a wired network interface or a wireless network, the latter including various wireless access technology including terrestrial radio access networks, wireless local area or wide area networks, or the like.

Multimedia playback device 100 can comprise a single sign on (SSO) registration apparatus 104 communicatively connected to communication interface 102. Additionally, SSO registration apparatus 104 can be communicatively connected to a data store 108. SSO registration apparatus 104 can comprise a memory 112 for storing computer-executable components, and a processor 110 communicatively connected to the memory and configured to facilitate execution of at least one of the computer-executable components. Execution of some or all of these components can serve to implement the configurations or functionality of SSO registration apparatus 104, as described in more detail below.

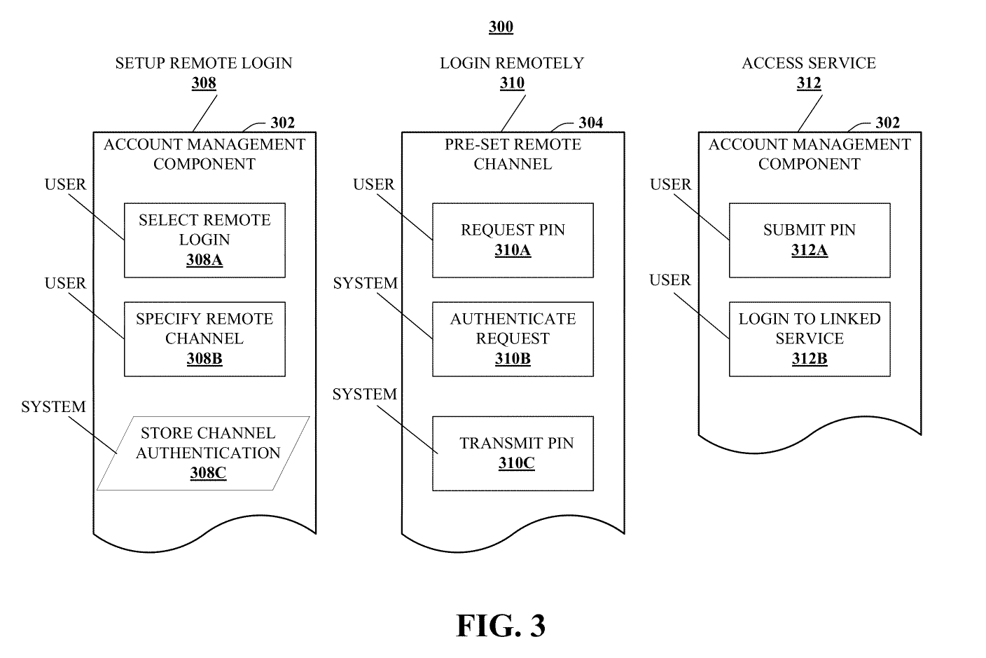

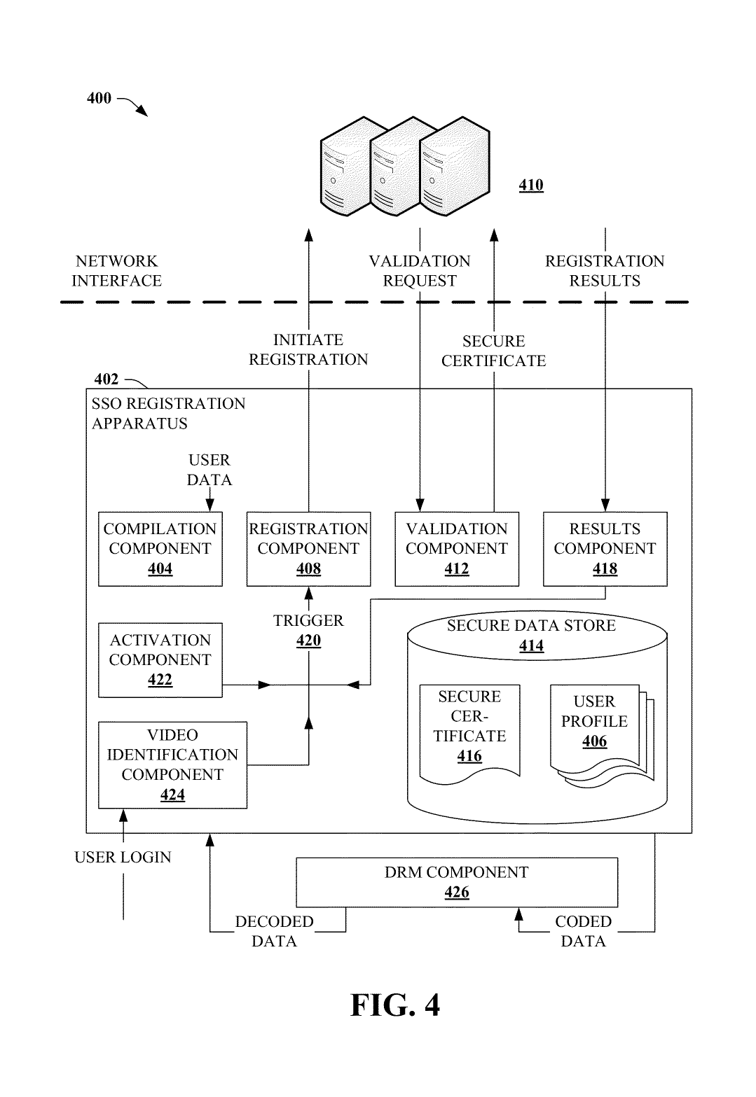

SSO registration apparatus 104 can be configured to provide automated registration to a set of network or local applications, facilitating user account creation and content/service acquisition with greatly reduced overhead for the user. Additionally, the automated registration can facilitate ease of access to content or services provided by successfully registered applications at multimedia display device 100, or a suitable remote access device (e.g., see FIGS. 3 and 4, infra).

SSO registration apparatus 104 can comprise an account management component 106 that can be configured to facilitate creation of an automated registration account for a user of multimedia playback device 100, and store at least a subset of data pertaining to the automated registration account at data store 108. The automated registration account and related user information can be utilized by SSO registration apparatus 104 to register a user with network-based or local client-based applications. Respective user accounts for those applications can be created by SSO registration apparatus 104 in response to successful registration. User access to content/services associated with those applications can be conveniently acquired in response to activation of a local application or application shortcut stored at multimedia playback device 100—involving just one or a few manual button presses on a human machine interface (HMI), as one example, minimizing user overhead in accessing application content or services.

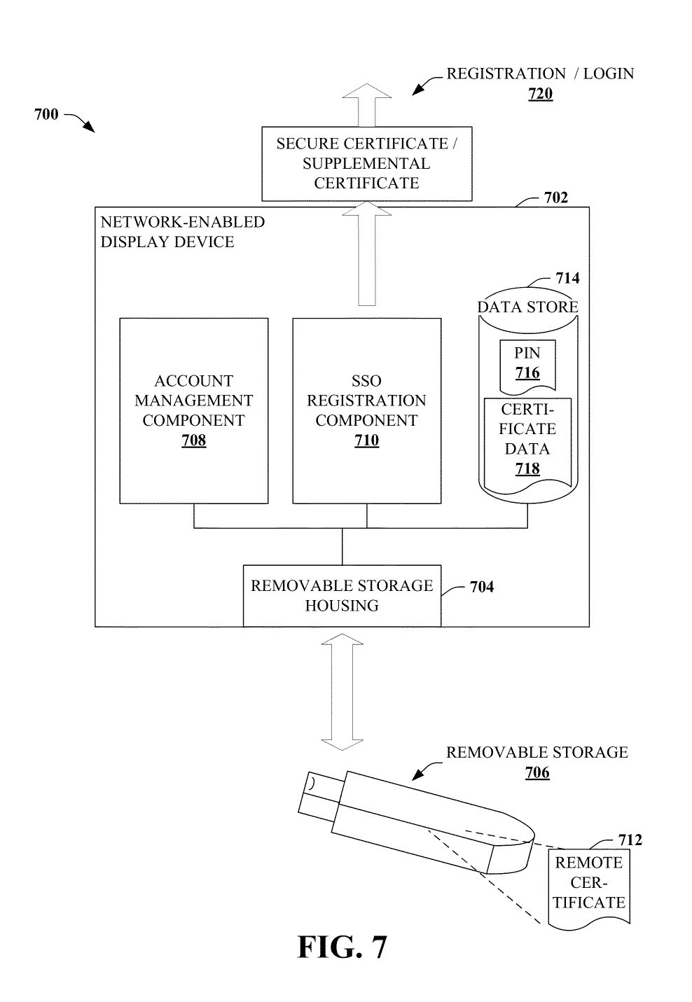

In at least one aspect, SSO registration can employ a secure data certificate, such as a digital certificate, encrypted data card, or the like, for user verification in registering the user with one or more applications. In a particular aspect, the secure data certificate or a copy thereof can be stored on a removable storage device, enabling a user to activate SSO registration or verify user identity in association with acquiring application content or services, from a plurality of multimedia display devices configured to accept and read the removable storage device (e.g., see FIG. 7, infra). In other aspects, SSO registration or access to associated application content can be enabled for a remote device, communicating over a network with multimedia playback device 100 (e.g., see FIGS. 3 and 4, infra).

In operation, account management component 106 can be configured to display an option at multimedia playback device 100 enabling a user to initiate SSO registration. Upon user selection of the option, account management component 106 can be configured to generate a registration account for the user, and store data associated with the registration account at data store 108. Particularly, account management component 106 can be configured to query the user for a set of applications to be linked with the registration account, and a set of information associated with the user for registering the user with the respective applications. The set of applications can include any suitable network-based content or service application, or a local-client application that executes on multimedia playback device 100. Examples can include multimedia content applications (e.g., audio-video content such as television shows or movies, audio content such as radio broadcasts, songs, concerts, and the like, or general audio or video content in various formats and codecs), social network applications, e-mail or other inter-personal communication applications, network-based commerce applications, and so on. Local-client applications can comprise any suitable code or program for operating multimedia display device 100, acquiring, configuring or playing content or services for use or consumption at multimedia display device 100, transmitting or receiving communication data, posting or viewing content on a website, or other applications ancillary to acquiring or playing content that can be executed on a computing device.

The user information acquired by account management component 106 can be information pertinent to registering a user for the set of applications linked with the registration account. Examples of such information can include name, mailing address, home address, business address, contact information, e-mail information, mobile phone information, login information for social network, blog, forum, or other Internet site, payment information, content/service usage information, or the like, or a suitable combination thereof.

In some disclosed aspects, account management component 106 can enable a user to set privacy filters for different subsets of the user data. Privacy filters can be utilized to limit access to or transmission of a subset of the user data. Limitations can be predetermined conditions established by a user and provided to account management component 106.

Privacy filters can be configured individually for respective subsets of user data. A privacy filter can, for instance, stipulate that a subset of user data is not to be accessed or transmitted except where one or more conditions established in conjunction with the privacy filter is met. Suitable conditions can include, registration for a particular application, a security query and verified response (e.g., verified by username and password, by digital certificate or entry of storage device comprising a digital certificate—see FIG. 7, infra, by utilizing an authorized device to respond to the query analogous to remote access described at FIG. 3, infra, or the like), access to a specified content or service, and so on. Account management component 106 can facilitate access to a subset of data having a privacy filter when the condition(s) specified with the privacy filter is met, and prevent access to the subset of data otherwise. As an example, a user can restrict output of billing information only for a predetermined application, or only in response to a query by account management component 106 and verified user approval of the query (e.g., output at multimedia display device 100, or a remote access channel such as a cell phone, e-mail account, messaging or text account, web-page, . . . ), or the like. As yet another example, the user can restrict address and contact information for a selected subset of applications, while restricting the address and contact information for non-selected applications, or for a second selected subset of applications, and so on.

Once a registration account is established for a user and related data (or specified privacy filters) are stored at data store 108, SSO registration apparatus 104 can attempt to register the user with the set of applications linked to the registration account. To accomplish registration, SSO registration apparatus 104 can comprise a registration component 114 configured to initiate a communication over communication interface 102 with a set of registration servers that are associated with the set of applications linked to a user's registration account. A network address for the registration servers can be input by the user in conjunction with specifying the set of applications, or can be obtained (e.g., via network query, by performing an HTML request with a link to an application, or the like) by account management component 106 in response to receiving the set of applications. Upon establishing the communication, registration component can be configured to identify subsets of user data requested by respective registration servers as part of registering for content or a service associated with the respective applications.

Additionally, SSO registration apparatus 104 can comprise a compilation component 116 configured to acquire the identified subsets of user data. Compilation component 116 can attempt to extract the subsets of user data from data store 108. Commonly utilized registration information, such as user name, e-mail address, contact information, etc., may be included within data store 108 as part of establishing a registration account, as discussed above. Data not saved onto data store 108 can be submitted in a query to a user of multimedia playback device 100.

To acquire additional information, compilation component 116 can be configured to generate a set of data fields and an associated set of data labels that specify respective subsets of information requested by one or more registration servers. The data fields and data labels can be output for receipt of user data. In particular aspects of the subject disclosure, the data fields and data labels can be output at a display screen of multimedia playback device 100. In other aspects, the data fields and data labels can be output to a computing device accessible over communication interface 102 (e.g., connected to a local area network, wide area network, mobile network, the Internet, or other suitable data network). In at least one aspect, the data fields and data labels can be output to a communication account registered to the user. Example communication accounts can include an e-mail account, whether web-based or based on an intranet, a mobile phone account, a messaging account, a social networking account, Internet forum, blog, or the like, or a suitable combination thereof.

Data acquired by compilation component 116 can be submitted to respective ones of the set of registration servers by registration component 114. Particularly, registration component 114 can auto-fill data requested by respective ones of the registration servers for registering a user with an associated content or service application. Where user verification is requested by one or more of the registration servers, a validation component 118 can be configured to store information pertaining to the user in the form of a secure data certificate. The secure data certificate, in turn, can be provided to at least one of the set of registration servers in response to a user verification request.

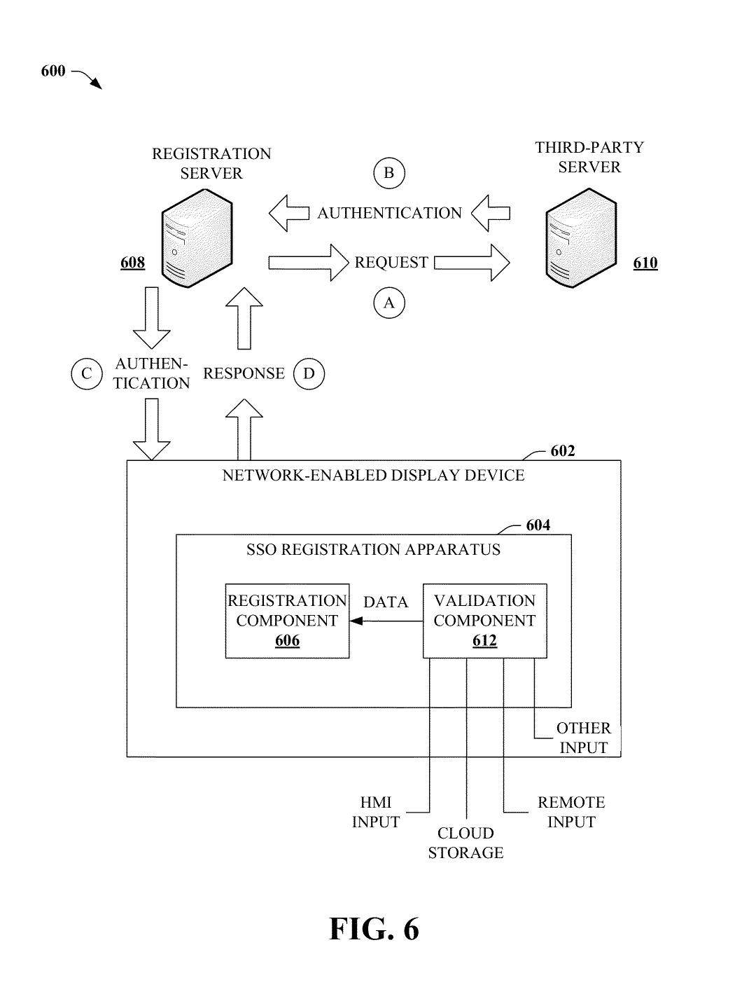

For some registration servers, user verification is not required and a user account associated with a particular content or service application can be created in response to registration component 114 providing requested information. Other registration servers may require user verification, and in such case a user account for content or services associated with those registration servers can be created in response to receipt of the secure data certificate from SSO registration apparatus 104, and acceptance thereof. In at least one aspect of the subject disclosure, SSO registration apparatus 104 can employ third-party user verification in lieu of or in conjunction with user verification via the secure data certificate (e.g., see FIG. 6, infra). In at least one other aspect, SSO registration apparatus 104 can facilitate storage and access to the secure data certificate via a removable storage device (e.g., see FIG. 7, infra).

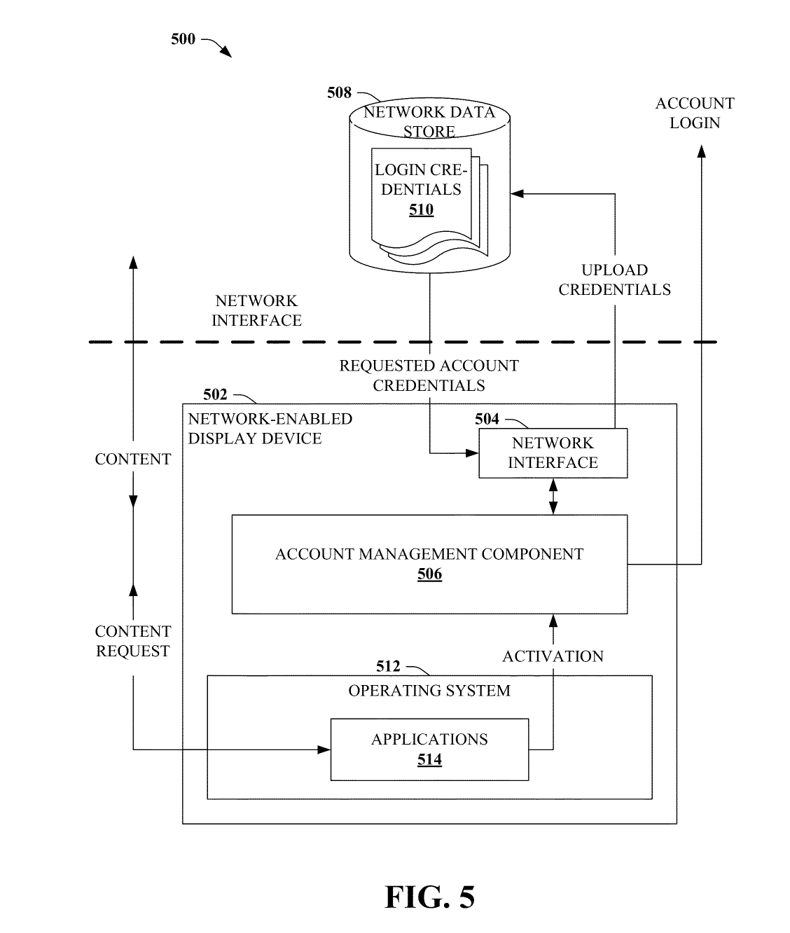

Successful registration can be transmitted by respective registration servers to SSO registration apparatus 104. Account management component 106 can generate user login credentials (e.g., username or password, which can be generated by an algorithm configured to generate the username or password as a hard-to-guess, or hard to hack data string(s)) for respective user accounts for each successful registration. User login credentials can be stored at data store 108, or stored remotely (e.g., see FIG. 5, infra). When a user activates an application, or shortcut to such an application at multimedia playback device 100 (or a suitably preconfigured remote access device), account management component 106 can be configured to retrieve respective login credentials for the activated application, sign on the user to an associated account, and facilitate access to content or services provided by the application.

As described, SSO registration apparatus 104 can significantly reduce user overhead involved in registering for online or local client applications. Additionally, SSO registration apparatus 104 can reduce user overhead in accessing content provided in response to successful registration. Accordingly, a significant advantage can be achieved in conjunction with a multimedia display device 100, in which a user can obtain access to a wide variety of content through automated processes that save time and effort for the user. This in turn can increase user enjoyment of multimedia display device 100, and differentiate such device from other such devices.

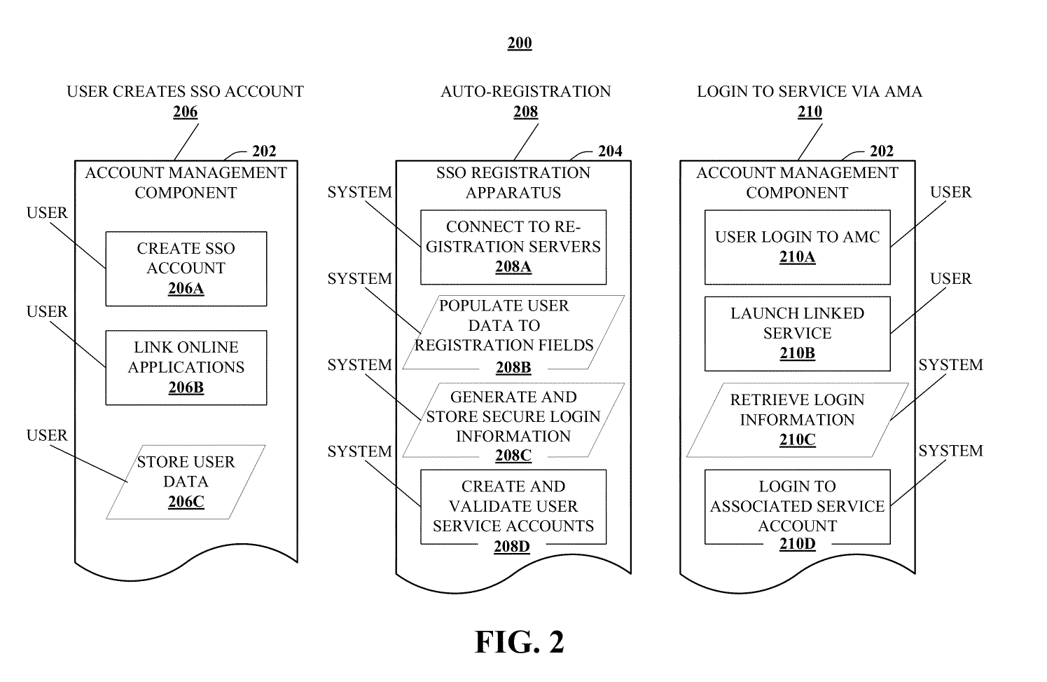

FIG. 2 illustrates a block diagram of an example system 200 for providing SSO registration according to additional aspects of the subject disclosure.

FIG. 2 illustrates components of system 200, including account management apparatus 202 and SSO registration apparatus 204. Additionally, respective descriptive objects are illustrated within the different components, with square-shaped objects generally denoting a process or action performed, and trapezoidal-shaped objects generally denoting data-related activities.

At the left of FIG. 2, an account management component 202 is illustrated to facilitate user creation of an SSO registration account 206. Account management apparatus 202 can be configured for an action 206A to facilitate creation of an SSO registration account for a user of a multimedia playback device (e.g., network-enabled television device, computer, tablet PC, . . . ). Creation of the SSO registration account is in response to user selection, though the user selection can be in response to a query from account management component 202, or can be initiated by the user. In addition, account management component 202 can be configured to perform an action 206B of linking online or local applications specified by the user, to the SSO registration account. Further, account management apparatus 202 can be configured for an action 206C comprising storing user data provided by the user.

At the middle of FIG. 2 is depicted an SSO registration apparatus 204 configured for automated user registration for application content or services 208. SSO registration apparatus 204 can be configured for an action 208A of connecting to a set of registration servers associated with the online or local applications linked to the SSO registration account. Further, SSO registration apparatus 204 can be configured for an action 208B of populating user data fields provided by respective registration servers with user data obtained from the stored user data. Additionally, SSO registration apparatus 204 can be configured for an action 208C of generating and storing secure login information in response to successfully registering the user with a subset of the online or local applications. SSO registration apparatus 204 can also be configured for an action 208D of creating respective user accounts and login credentials (e.g., hard-to-guess username and password, . . . ) and associated user accounts for successfully registered applications, and to validate the user in conjunction with application servers requesting user validation. In at least one disclosed aspect, the user validation can be accomplished via a secure data certificate, stored locally at SSO registration apparatus 204, stored remotely, or stored at a removable data store communicatively connected to SSO registration apparatus 204. According to one or more further aspects, the secure data certificate can include information particular to the user related to authorizing user-dependent content or services (e.g., age information to authorize age-related content or services, such as parental controls).

On the right of FIG. 3 is depicted account management apparatus 202 further configured to facilitate user login to an application service 210 and accessing content at the multimedia playback device. Account management apparatus 202 can be configured to facilitate a user action 210A of logging into a user account associated with the multimedia playback device, and to facilitate a user action 210B of launching a linked service application. Account management component can be configured for an action 210C of retrieving stored login credentials associated with the linked service application, and an action 210D of logging into a service associated with the linked service application. Upon successful login to the service, content provided by the service can be accessed at the multimedia playback device. Moreover, each of the registered service accounts can be automatically accessed by the user simply by launching an associated application, link, shortcut, service, etc., at the multimedia playback device. In response, account management component 202 can automatically retrieve the stored login credentials, and log the user in to the registered account(s). This automated registration and account login can provide a valuable service to a user, and increase a likelihood of the user employing the multimedia playback device as a common medium for accessing a wide array of application services and content.

FIG. 3 illustrates a diagram of an example system 300 for providing remote user access in conjunction with SSO registration according to still other aspects of the subject disclosure. System 300 can comprise an account management apparatus 302 configured to facilitate establishing a remote login access 308 for user access to account registration functionality, as described herein, or content/service access provided by a content or service-related application. Account management apparatus 302 can be configured to facilitate a user action 308A for selecting or activating a remote login function of account management apparatus 302. In addition, account management apparatus 302 can facilitate a user action 308B of specifying a remote communication channel over which the remote access can be provided. The remote communication channel can be an e-mail communication, mobile phone message or phone call, network communication from a computer, laptop, tablet PC, or the like, or a suitable combination thereof. Account management apparatus can further be configured to implement an action 308C of storing information pertaining to the specified remote communication channel to recognize and authorize a content request received by system 300 from the specified communication channel.

At the center of FIG. 3 is depicted a pre-set remote communication channel 304 for facilitating remote login to SSO registration, or to content or services managed by a SSO account management. As mentioned above, pre-set remote communication channel 304 can comprise a predetermined e-mail communication, mobile phone call, network request, and so on. Pre-set remote communication channel 304 facilitates an action 310A of transmission of a personal identification code (PIN) request from a device. Additionally, pre-set communication channel 304 can facilitate an action 310B of authenticating the PIN request. In one aspect, authentication can be based on identifying information of a device transmitting the PIN request. Such identifying information can include, e.g., a device serial number, a mobile device phone number or other suitable mobile device identifier (e.g., an IMEI, . . . ), a computer identifier (e.g., MAC address, network address, . . . ), a subscription account number for device service provider (e.g., a subscription number for online television content related to a network-enabled television device linked to the subscription number), and so on. In alternative, or additional aspects of the subject disclosure, authentication can be based on identifying information of a user, such as a username and password, pre-stored authentication PIN, or user-entered code, or the like. In yet another aspect, authentication can comprise exchange of a digital certificate between the device and account management component 302. In still other aspects, a combination of the foregoing authentication mechanisms can be utilized. In response to unsuccessful authentication of the request for PIN, the PIN request is denied. In response to successful authentication on the other hand, pre-set remote channel 304 can facilitate an action 310C of transmission of a remote access PIN to the device.

On the right side of FIG. 3, account management apparatus 302 can facilitate access to the linked service 312. Particularly, account management component can facilitate a user action 312A of submitting the remote access PIN, and verify that the submitted PIN matches the transmitted PIN. In response to successfully matching the transmitted PIN with the submitted PIN, account management apparatus 302 can be configured to implement an action 312B of logging into a linked service and providing access to content or services associated therewith. Logging into the linked service can involve retrieving stored login credentials for the linked service, and submitting the stored login credentials to a login server associated with the linked service. Upon successful login, content can be provided to the remote device for user consumption.

In one or more alternative, or additional aspects of the subject disclosure, a user can specify multiple remote communication channels for remote access to linked accounts managed by account management component 302. The user can, for instance, specify a preference for the communication channels (e.g., first priority, second priority, etc.), or specify application, content or access limitations for one or more of the respective communication channels. In further aspects, the remote access PIN can be a one-time PIN that is generated uniquely for the request and invalidated for remote access by account management component 302 after successful or unsuccessful remote access login in response to the PIN. In an alternative aspect, the remote access PIN can be a limited access PIN generated for a predetermined number of remote access requests (e.g., for five remote access requests, . . . ) before invalidation. In yet other aspects, the remote access PIN can have indefinite duration or login requests before invalidation (e.g., invalidation upon user specification, upon a random number of login requests, . . . ). According to at least one additional aspect, account management component 302 can erase and regenerate login credentials for linked accounts that can be accessed through the remote access PIN, to mitigate the login credentials being compromised by unauthorized remote access. In alternative, or additional aspects, the remote access PIN can be active for a limited time duration, and in which case a user is logged into a linked service remotely in response to a user submitted PIN being received before expiration fo the limited time duration, matching the remote access PIN. Otherwise, a new PIN request is required. Further to the above, multiple mechanisms for request, transmission and authentication of a remote access PIN are envisioned as within the scope of the subject disclosure. A simple example can include user request, followed by a reply with PIN. A more complex example can include the user request, followed by a confirmation of the request, then followed by authentication of the PIN, and finally by replay to the request. In at least one aspect, which can be another alternative to or can be in addition to one or more of the foregoing, remote access can involve a call over the pre-set communication channel 304 to a support center and entry (electronically to an automated system, or personally to a human operator) of a PIN or pass code for authorizing remote access.

FIG. 4 depicts a block diagram of an example client-server communication 400 related to SSO registration according to particular aspects of the subject disclosure. Client-server communication 400 can comprise a SSO registration apparatus 402 configured to auto-fill registration data fields with subsets of user information, to register a user(s) with a set of online content or service applications. User data entered one or a limited number of times can be replicated to reduce overhead associated with registering for multiple accounts. In addition, a user can set privacy flags for subsets of user data, limiting conditions under which respective subsets of data can be accessed, or provided in conjunction with performing the registrations. Moreover, successfully registered content or service applications can be linked with an account(s) associated with the user(s), facilitating ease-of-access to linked content or services at a network-enabled multimedia display device, associated with multimedia playback. Accordingly, SSO registration apparatus 402 can be configured to provide significant advantages to users of such a display device.

SSO registration apparatus 402 can comprise a compilation component 404 configured to acquire and compile subsets of user data. Data can be compiled as a function of type of user information (name, location information, contact information, billing information, login information for related user accounts, . . . ) in broad categories, specific categories, or varying ranges there between. Additionally, compilation component 404 can be configured to acquire user input indicative of one or more online or local content or service applications to which a user would like to access via SSO registration. It should be appreciated that compilation component 404 can acquire respective user data and respective content or service application input for a set of users, and store respective user information in a set of user profiles 406 for respective users.

SSO registration apparatus 402 can further comprise a registration component 408 configured to initiate communication with a set of registration servers 410, configured to facilitate user registration for respective content or service applications. Registration apparatus 402 can receive requests for user data (e.g., data fields) from registration servers 410 to facilitate completing a registration. Registration apparatus 402 can be configured to auto-fill subsets of data listed as mandatory by a particular registration server 410, or can auto-fill all subsets of data, per user preference (e.g., based on a user-configured privacy flag(s), described herein).

Registration component 408 can be further configured to identify or obtain a label or category for data required by a registration server 410 that has not been previously compiled by compilation component 404. A data request for such information can be output to a user; for instance, at a display of a network-enabled multimedia playback device, transmitted to a networked computer, sent to an e-mail address, sent to a mobile phone (e.g., via e-mail, text message, voice message, short message service message, multimedia message service message, . . . ), or the like. Data received in response to the data request can be auto-populated to data fields associated with application registration.

In particular aspects of the subject disclosure, user verification can be requested by a registration server 410 in conjunction with completing registration of a user account. A validation request can be received by a validation component 412, which can be configured to store information pertaining to a user in the form of a secure data certificate 416 in a secure data store 414, and provide the secure data certificate 416 to one or more registration servers 410 in response to respective requests for user validation. In an aspect(s), the secure data certificate 416 can comprise information indicative of a user to facilitate user-specific services, or limitations (e.g., user age for parental control limitations). In other aspects, the secure data certificate 416 can be stored on a removable storage device (e.g., see FIG. 7, infra). It should be appreciated that the secure data certificate 416 can be an encrypted digital certificate, an encoded set of data transmitted via a secure communication between SSO registration apparatus 402 and registration servers 410, or other suitable alternative.

SSO registration apparatus 402 can further comprise a results component 418. Results component can be configured to receive registration results from one or more of the set of registration servers and save successfully registered application services in conjunction with user profile 406 for respective users. Results component 418 can further be configured to display or otherwise output a list of successfully registered applications, as well as unsuccessfully registered applications. Thus, a user can be informed of what applications are available for access, and what applications re-registration can be attempted. Where unsuccessful registration occurs for one or more applications linked to a user profile 406, results component 418 can output a query as to whether to proceed with a subsequent SSO registration for unsuccessfully registered applications. The query can facilitate, for instance, user input of additional data requested by a registration server 410 denying a registration, or user input of a secure data certificate or other user validation mechanism required by the registration server 410 (e.g., a third-party user validation, see FIG. 6, infra, a removable data certificate, see FIG. 7, infra). If user input specifies re-registration, results component 418 can send a trigger 420 to registration component 408 to re-initiate SSO registration.

In a further aspect of the subject disclosure, secure certificate 416 can be utilized to store billing or charging information for a user having an SSO registration account. The billing and charging information can be provided to registration server 410 as part of registering for a content/service account on behalf of the user. In one aspect, the billing information can be uploaded with secure certificate 416 and stored at a registration server(s) 410 in conjunction with registering for the content/service account with one of registration server(s) 410. In this aspect, the billing information can be accessed by a service provider for charging functions pertaining to content/services requested by the user and provided under the content/service account. In another aspect, access to the billing information can be limited—such as a one-time access, a non-replicable access, an encrypted access, or the like—for the limited purpose of identifying or authorizing a user in conjunction with registering for the content/service account. In various other aspects, secure certificate 416 could be employed on a pay-per-use or periodic payment basis by an application residing on a network-enabled display device associated with SSO registration apparatus 402 (e.g., see FIG. 5, infra). For instance, where a user initiates an application to request content under a content/service account created via the registration functionality described herein, and agrees to a cost for the content/service account, the application could access secure certificate 416 for payment of the cost. Particularly, the application could submit secure certificate 416 or billing information stored thereon to a charging entity (not depicted) related to the content/service account to complete payment for the cost of the content/service. Such payment can require a user input in response to a query, a verified user input (e.g., utilizing related login credentials, password, PIN, or requiring a biometric user input, written signature, and so on), or the like.

In at least one alternative or additional aspect of the subject disclosure, SSO registration apparatus 402 can comprise an activation component 422. Activation component 422 can be configured to establish a condition, upon occurrence of which SSO registration as described herein is triggered 420 for network or local applications linked with one or more user profiles 406. The condition can comprise any suitable electronic activity, hardware or software process, series of processes/activities, or the like, related to SSO registration apparatus 402, a user profile 406 maintained by SSO registration apparatus 402, a network-enabled display device encompassing SSO registration apparatus 402 or communicatively connected to SSO registration apparatus 402, or a suitable combination thereof. Activation component 422 can be further configured to monitor SSO registration apparatus 402, user profile 406, a network-enabled display device, etc., for occurrence of the activity, and sends a trigger 420 to registration component 408 to initiate SSO registration in response to satisfaction of the condition. As possible example, activation component 422 can be configured to trigger SSO registration in response to the network-enabled display device being powered on, in response to a user completing a user profile 406, in response to a user updating a user profile 406 to include requested user registration information, in response to updating secure data certificate 416, in response to a removable storage device comprising a secure data certificate being communicatively connected to SSO registration apparatus 402, and so on. It should be appreciated that other examples known to one of ordinary skill in the art, or made known to one of ordinary skill by way of the context provided herein, are considered within the scope of the subject disclosure.

According to a particular aspect, SSO registration apparatus 402 can further comprise a video identification component 424. Video identification component 424 can be configured to employ visual user authentication in conjunction with SSO registration, including creating a user profile 406, creating a secure data certificate 416, accepting a removable storage device and secure data certificate contained thereon, initiating SSO registration, and like operations of SSO registration apparatus 402. For instance, video identification component 424 can be configured to output a video identification code for display at a network-enabled display device associated with SSO registration apparatus 402 in conjunction with one or more of the above operations of SSO registration apparatus 402, or a like operation. As a specific example, video identification component 424 can output the video identification code to facilitate user login to a user profile 406 associated with a user of the network-enabled display device, or to facilitate user creation of a SSO registration account, as described at FIGS. 1 and 2, supra. Successful user login via by proper user input of the video identification code can trigger SSO registration apparatus 402 to initiate one or more functions of SSO registration apparatus 402 (e.g., creation of a SSO registration account for the successful login, creating/updating the user profile 406 for an existing account, creating/updating a secure data certificate 416, specifying/updating remote login access as described at FIG. 3, supra, configuring removable storage device user validation (e.g., via a removable secure data certificate), or like functions of SSO registration or related functionality described herein, or suitable combinations thereof.

According to one or more additional aspects of the subject disclosure, SSO registration apparatus 402 can comprise a digital rights management (DRM) component 426. DRM component 426 can be configured to decode information transmitted by registration servers 410 that is encoded in a DRM protocol. Such encoding can be utilized to limit registration of application content or services to DRM enabled devices, for instance. As an example, a validation request or registration results transmitted by one or more registration servers 410 in accordance with a DRM protocol can be provided to DRM component 426. DRM component 426 can perform a check for DRM compliance with a display device connected to SSO registration apparatus 402. If compliance is detected, DRM component 426 can decode the validation request or registration results, and provided decoded information to SSR registration apparatus 402. Otherwise, a DRM error can be output instead, indicating that no DRM-compliant device can be found. Additionally, DRM component 426 can provide a request for DRM encoding to the set of registration servers in response to the network-enabled display device complying with the DRM protocol.

FIG. 5 depicts a block diagram of an example system 500 for managing one or more registered application accounts according to further aspects of the subject disclosure. System 500 can comprise a network-enabled display device 502, having a network interface 504 for communicating over a data network, such as the Internet. An account management component 506 can be configured to generate and upload login credentials for a set of application accounts created for a user of network-enabled display device 502 (e.g., in response to successful SSO registration, as described herein). The login credentials can be generated to be difficult to guess or code-break, utilizing characters from a variety of alphabets, numbering systems, keyboard keystrokes, HMI input keys, or the like, or a suitable combination thereof. Respective codes can be generated for each application account, for each user, managed by account management component 506. Utilizing network interface 504, these codes can be stored at a network data store 508 (e.g., cloud storage) in a set of login credentials files 510.

Upon activation of an application 514 at an operating system 512 of network-enabled display device 502, account management component 506 can identify a user and application account associated with the activated application 514, and retrieve a matching code for the activated application from network data store 508. The retrieved code can be transmitted to a login server (not depicted) associated with a content provider for the activated application. If login is successful, account management component 506 can display a notification at network-enabled display device 502, indicating successful account login and access to content or services associated with the application. The activated application 514 and operating system 512 can then transmit content requests, and receive content over network interface 504.

FIG. 6 depicts a block diagram of an example system 600 for integrating third-party user authorization with SSO registration according to one or more other aspects of the subject disclosure. System 600 can comprise a network-enabled display device 602 comprising, or communicatively connected to, a SSO registration apparatus 604. As described herein, a registration component 606 can initiate a registration for a user account related to an online or local content or service application on network-enabled display device 602. Upon receiving a registration request, a registration server 608 can request user verification from a third-party server 610. Third-party server 610 can comprise, for instance, an e-mail verification server, a social network verification server, a website verification server, a mobile phone subscriber verification server, or the like. An authentication response transmitted by third-party server 610 can request data input of predetermined login credentials for a particular user, stored by third-party server 610. The authentication response is relayed by registration server 608 to network-enabled display device 602.

Upon receiving the authentication response, a validation component 612 can be configured to attempt to acquire the predetermined login credentials requested by the authentication response. Validation component 612 can reference a network data store to determine whether third-party credentials are stored for the user, and if so transmit the stored third-party credentials in response to the authentication response. If no third-party credentials are stored, or an error is transmitted by third-party server 610 in response to stored third-party credentials, validation component 612 can reference a user account for user preferences for providing third-party authentication data. Such a preference could indicate HMI input, in which a request for the third-party login credentials can be displayed at network-enabled display device 602, and entered via HMI input (e.g., a remote control, . . . ). A preference could also include remote input through a predetermined communication channel, such as an e-mail account, text message account, mobile phone call, or the like. In such case, validation component 612 can transmit the request for third-party login credentials via the predetermined communication channel. Other input mechanisms can be employed as well and utilized for requesting the third-party login credentials.

Upon receiving third-party login credentials via user input, validation component can submit the credentials to registration server 608. Registration server 608 in turn relays the credentials to third-party server 610. If the credentials match the predetermined login credentials stored by third-party server 610, an authentication approval can be transmitted to registration server 608. In response to receiving the authentication approval, registration server 608 can allow the registration request and create an application account for the user, based on account login credentials generated by SSO registration apparatus 604. Access to the account can be managed as described above at FIG. 5, infra.

FIG. 7 illustrates a block diagram of an example system 700 for implementing user verification in conjunction with SSO registration according to still other aspects of the subject disclosure. Particularly, the user verification can be based on a digital certificate stored on a removable storage device 706. Removable storage device 706 can be removably connected to a removable storage housing 704 on a network-enabled display device 702. Alternatively, removable storage housing 704 can be located on a control unit, set-top box, or other device communicatively connected to network-enabled display device 702. Removable storage 706 can comprise a data card (e.g., magnetic storage device, electronic storage device, . . . ), a thumb drive, flash drive, external hard drive, or similar storage device.

Network-enabled display device 702 can comprise an account management component 708 for generating an SSO registration account(s) for one or more users of network-enabled display device 702, and acquiring a set of applications related to online content or services for respective SSO registration accounts. In addition, an SSO registration component 710 can automatically register users for services associated with the set of applications, as described herein. User verification can be implemented via a remote secure data certificate 712 (e.g., a digital certificate, . . . ) stored on removable storage 706. In response to communicatively connecting removable storage 706 to removable storage housing 704, SSO registration component 710 can be configured to trigger SSO registration for an SSO registration account associated with remote secure data certificate 712 stored on removable storage 706. In the event that multiple remote secure data certificates 712 associated with multiple users of network-enabled display device 702 are located on removable storage 706, SSO registration component 710 can initiate SSO registration for each user having an associated remote secure data certificate 712. As described herein, remote secure data certificates 712 can be submitted for user verification as part of a registration procedure 720 to registration servers requiring such verification. The user verification can, in some aspects, be employed in conjunction with user-based content or service limitations, such as age-related parental controls, or other content or service limitations.

In addition to the foregoing, access to user application content or services can be conditioned on communication with removable storage 706 and access to remote secure data certificate 712. For instance, account management component 708 can check for access to a user's remote secure data certificate 712 via removable storage housing 704 before logging a user in to an application account maintained by account management component 708. If access to the user's remote secure data certificate 712 is available, account management component 708 can respond to activation of an application on network-enabled display device by acquiring stored login credentials associated with the activated application, and logging the user in to a login server via a login procedure 720 (e.g., see FIG. 5, supra). In an analogous aspect, communication with removable storage 706 can be established as a condition or partial condition for payment of content/service consumption charges. In the event that remote secure data certificate 712 comprises billing information pertaining to a user, remote secure data certificate 712 or the billing information can be accessed via removable storage housing 704, and utilized to authorize access to and payment of pay-per-view content, as one example, or some other electronic purchase (e.g., a purchase at an online store or website). When access to remote secure data certificate 712 is not available, payment for content/services or purchases cannot be implemented utilizing remote secure data certificate 712. In at least one aspect, an additional user verification can be required to complete payment information in addition to access to remote secure data certificate 712c. The additional verification could include, for instance, a password, PIN, login credentials, biometric identification (e.g., fingerprint on a fingerprint scanner, iris scan, . . . ), a passcode, a third-party user verification, such as depicted at FIG. 6, supra, (e.g., logging into third-party account maintained by the user, other than an account under which content/services or a purchase is being authorized for), or the like, or a suitable combination thereof.

In at least one aspect of the subject disclosure, account management component 708 can facilitate an alternate login procedure bypassing the removable storage 706. To implement the alternate login procedure, data stored on remote secure data certificate(s) 712 can be replicated in a certificate data file 718 on a data store associated with network-enabled display device 702, along with a user PIN stored in a PIN file 716 of data store 714. By entering a user PIN that matches the stored PIN in PIN file 716, account management component 708 or SSO registration component can access the replicated certificate data and generate a new secure data certificate for a user. The new secure data certificate can be utilized for account registration or account login 720, in lieu of the remote secure data certificate 712 stored on removable storage 706. Upon user command, the new secure data certificate can be written to removable storage 706 for later usage in conjunction with network-enabled display device 702.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include multimedia playback device 100 comprising SSO registration apparatus 402, account management component 302 and removable storage housing 704. Sub-components could also be implemented as components electrically connected to other sub-components rather than included within a parent component. Additionally, it should be noted that two or more components could be combined into a single component providing aggregate functionality. For instance, account management component 202 can comprise SSO registration apparatus 204 to facilitate creation of a SSO registration account, acquisition of user data and linked applications, and auto-registering the user for content/services related to those applications, by way of a single component. Components of the disclosed systems and apparatuses can also interact with one or more other components not specifically described herein but known by those of skill in the art, or made known to one of skill in the art by way of the context provided herein.

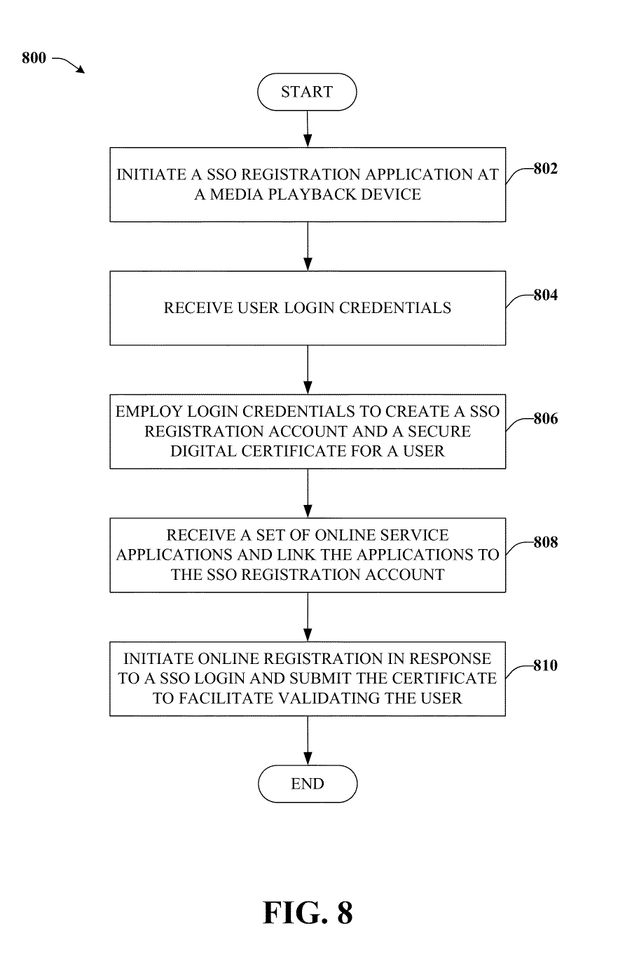

In view of the exemplary diagrams described supra, process methods that may be implemented in accordance with the disclosed subject matter will be better appreciated with reference to the flow chart of FIGS. 8-11. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 8 illustrates a flowchart of an example method 800 according to various aspects of the subject disclosure. Method 800 can be implemented, e.g., by a system including at least one processor, for providing SSO registration for online services through a media playback device. At 802, method 800 can comprise initiating by the system a SSO registration application at a media playback device. Such device can comprise a network-enabled television device, a multimedia content access and control device such as a television set-top box, or a computing device with audio-video display, or the like. At 804, method 800 can comprise receiving by the system user login credentials. Login credentials can be received over a HMI input device of the media playback device (e.g., a remote control, device buttons, . . . ), or from a network communication via a network interface associated with the media playback device. At 806, method 800 can comprise employing by the system the user login credentials to create a SSO registration account and a secure digital certificate for a user of the media playback device. At 808, method 800 can comprise receiving by the system a set of content or service applications related to local or network-based content/services, and linking the set of online service applications to the SSO registration account. At 810, method 800 can comprise initiating by the system online registration to the set of content or service applications in response to a successful login to the SSO registration account. Further, method 800 can comprise receiving by the system a user validation request from one or more registration servers associated with the online service applications, and submitting by the system the secure digital certificate to facilitate validating the user in conjunction with creation of a set of respective user accounts for respective ones of the set of content/service applications.

As described, method 800 can provide automated registration for local or network-based application content or services. Automated registration can include auto-filling registration data fields with user-related data for respective registrations. Additionally, automated registration can include automated user verification via a digital certificate, in at least one disclosed aspect. By performing application account registration automatically, a significant amount of user overhead involved in manually linking one or more applications with the media playback device can be reduced or eliminated, improving ease-of-use for the media playback device, and improving access to integrated content and services available for such a device.

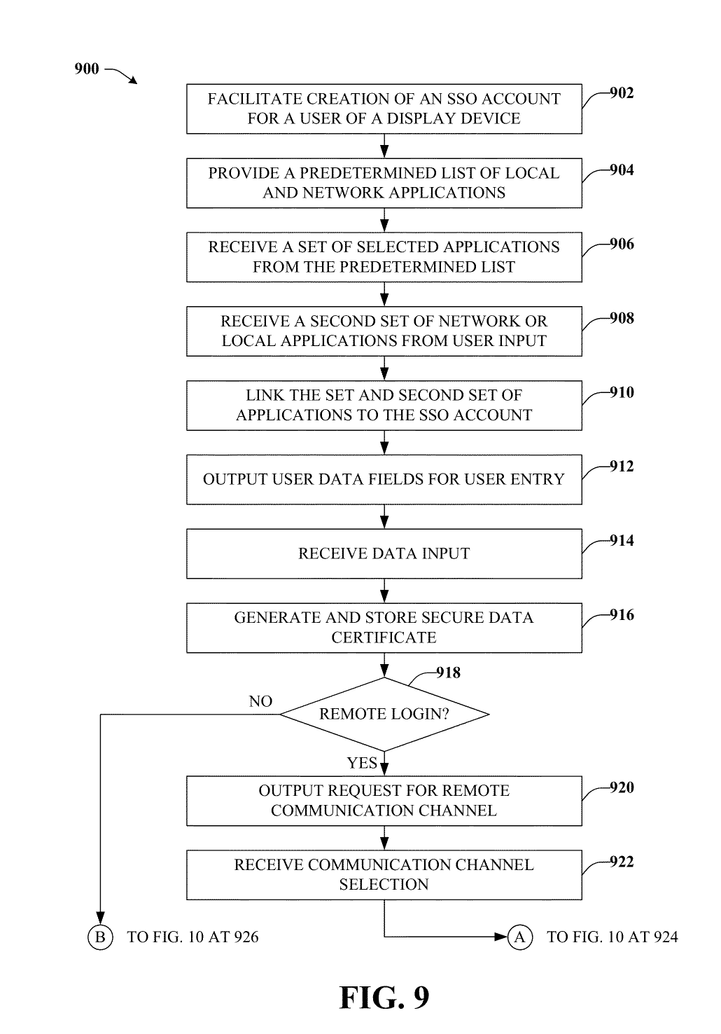

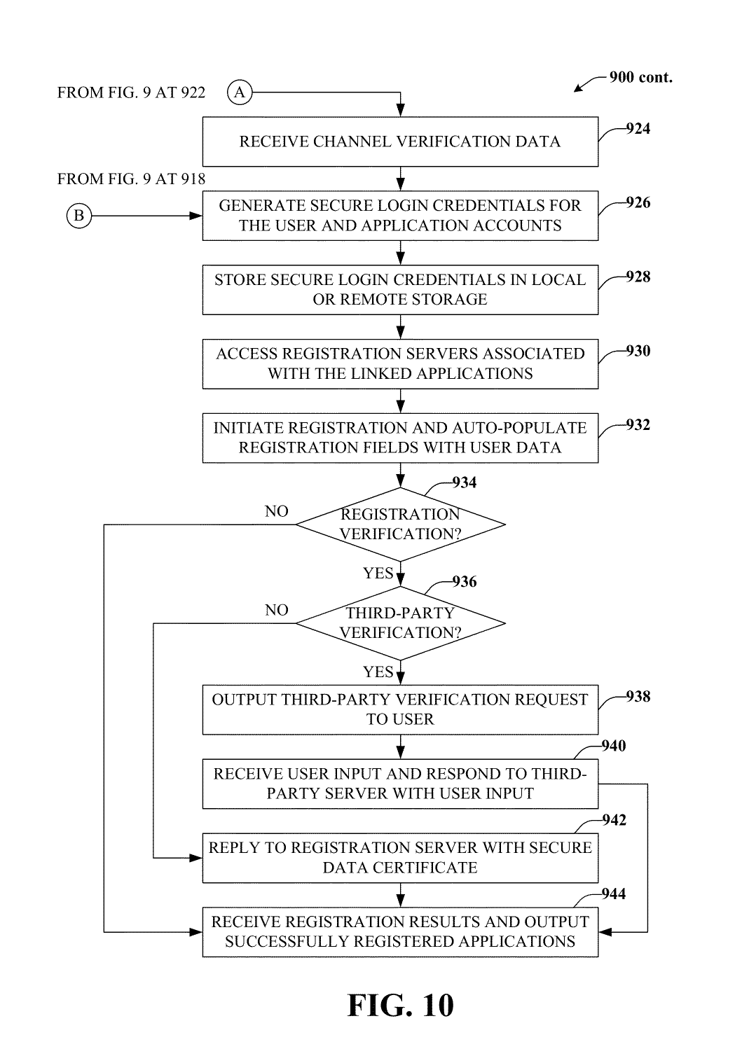

FIGS. 9 and 10 depict a flowchart of a sample method 900 for providing SSO registration for users of a network-enabled display device, according to alternative or additional aspects of the subject disclosure. At 902, method 900 can comprise facilitating creation of an SSO registration account for a user of the display device. At 904, method 900 can comprise providing a predetermined list of local or network-based applications for review by a user. The list of applications can be output at a video display of the display device, or transmitted over a network interface associated with the display device (e.g., to an e-mail account, network computer, mobile device, social network account, blog forum, . . . ). At 906, method 900 can comprise receiving a set of user-selected applications from the predetermined list. At 908, method 900 can comprise receiving a second set of network or local applications specified by user input. At 910, method 900 can comprise linking the set and the second set of applications to the SSO registration account.

At 912, method 900 can comprise outputting user data fields for user entry of data, and respective data labels specifying a category or description of the type of data requested for respective data fields. At 914, method 900 can comprise receiving user-related information for at least a subset of the data fields. At 916, method 900 can comprise generating and storing a secure data certificate for the user.

At 918, method 900 can comprise determining whether remote login is enabled for the SSO registration account. If remote login is enabled, method 900 can proceed to 920. If remote login is not enabled, method 900 can proceed to FIG. 10 at 926, infra.

At 920, method 900 can comprise outputting a request for remote communication channel. At 922, method 900 can comprise receiving a remote communication channel selection, and information specifying the communication channel. Such a channel can include a local area network or wide area network communication channel, an e-mail communication, text message, short message service message, or the like.

Referring now to FIG. 10, method 900 proceeds at 924, where method 900 can comprise receiving channel verification data for the remote communication channel. At 926, method 900 can comprise generating secure login credentials for prospective user accounts to be created for the content/service applications. At 928, method 900 can comprise storing secure login credentials in local or remote storage. At 930, method 900 can comprise accessing registration servers associated with the linked applications. At 932, method 900 can comprise initiating registration and auto-populating registration fields with subsets of the user data.

At 934, a determination can be made as to whether one or more user verification requests are received in conjunction with registering with the registration servers. If not, method 900 can proceed to 944, where method 900 can comprise receiving registration results and outputting successfully registered applications at the display device. Otherwise, method 900 can proceed to 936, where a determination is made as to whether the user verification request(s) is a third-party verification. If so, method 900 proceeds to 938; otherwise, method 900 proceeds to 942.

At 938, method 900 can comprise outputting third-party verification login credential request for user data response. At 940, method 900 can comprise receiving user input and responding to the third-party user verification request with data provided with the user input.

At 942, method 900 can comprise replying to a user verification request with a secure data certificate. At 944, method 900 concludes by receiving registration results from the registration server(s) and outputting successfully and unsuccessfully registered applications.

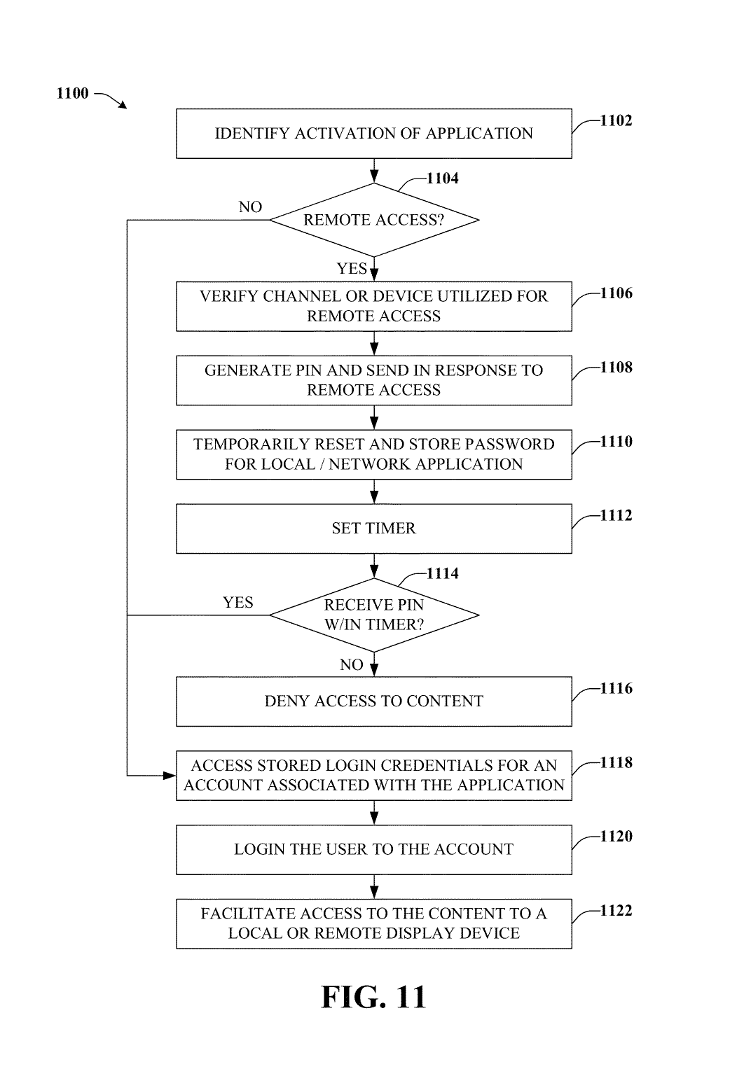

FIG. 11 illustrates a flowchart of a sample method 1100 for managing access to online content or services for a network-enabled display device according to particular aspects of the subject disclosure. At 1102, method 1100 can comprise identifying activation of an application related to acquiring online content or services at the network-enabled display device, or request to access an application for such activation. At 1104, method 1100 can comprise determining whether the activation is a result of a remote access. If not, method 1100 can proceed to 1118; otherwise method 1100 proceeds to 1106.

At 1106, method 1100 can comprise verifying a communication channel or communication device utilized for the remote access. At 1108, method 1100 can comprise generating a PIN and sending the PIN in response to the remote access. At 1110, method 1100 can comprise temporarily resetting and storing login credentials for the application. At 1112, method 1100 can comprise setting a timer for receipt of the PIN. At 1114, method 1100 can comprise determining whether the PIN is received within the timer. If not, method 1100 proceeds to 1116 and denies access to the application or content; otherwise method 1100 can proceed to 1118.

At 1118, method 1100 can comprise accessing stored login credentials for an account associated with the application. At 1120, method 1100 can comprise logging the user in to the account utilizing the stored login credentials. At 1122, method 1100 can comprise facilitating access to content or services related to the application at the display device, or at a remote display device in response to remote access.

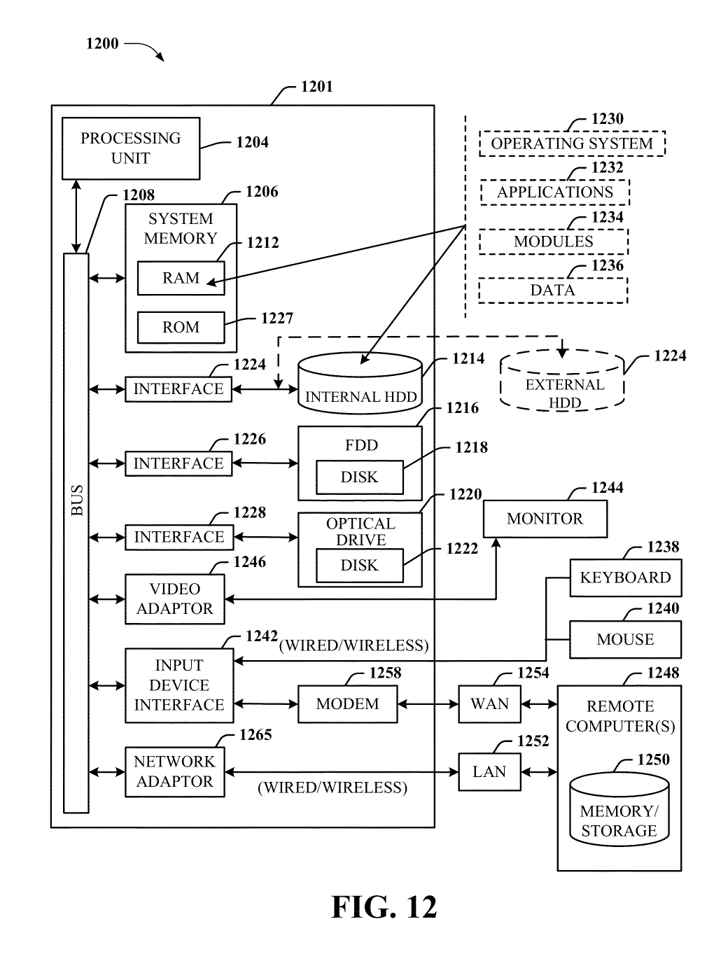

With reference to FIG. 12, an exemplary environment 1200 for implementing various aspects described herein includes a computer 1202, the computer 1202 including a processing unit 1204, a system memory 1206 and a system bus 1208.

The system bus 1208 connects system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1211 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that aspects of the subject disclosure can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 through an interface, such as a video adapter 1246. In addition to the monitor 1244, a computer typically includes other peripheral output devices (not shown), such as speakers, printers, etc.

The computer 1202 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or can be connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

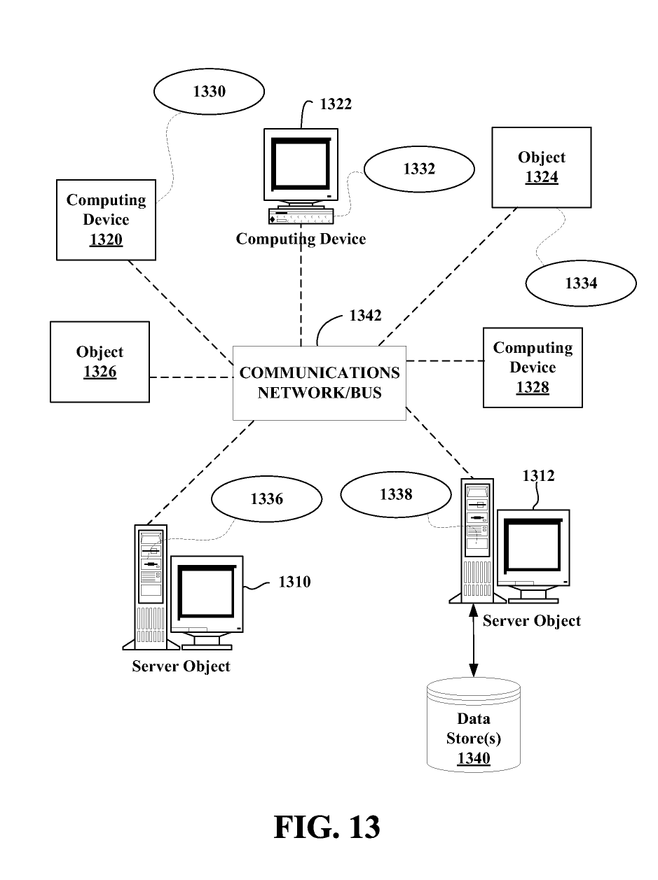

FIG. 13 provides a schematic diagram of an exemplary networked or distributed computing environment. The distributed computing environment comprises computing objects 1310, 1312, etc. and computing objects or devices 1320, 1322, 1324, 1326, 1328, etc., which may include programs, methods, data stores, programmable logic, etc., as represented by applications 1330, 1332, 1334, 1336, 1338 and data store(s) 1340. It can be appreciated that computing objects 1310, 1312, etc. and computing objects or devices 1320, 1322, 1324, 1326, 1328, etc. may comprise different devices, including multimedia display device 100 or similar devices depicted within the illustrations, or other devices such as a mobile phone, personal digital assistant (PDA), audio/video device, MP3 players, personal computer, laptop, etc. It should be further appreciated that data store(s) 1340 can include data store 108, or other similar data stores disclosed herein.

Each computing object 1310, 1312, etc. and computing objects or devices 1320, 1322, 1324, 1326, 1328, etc. can communicate with one or more other computing objects 1310, 1312, etc. and computing objects or devices 1320, 1322, 1324, 1326, 1328, etc. by way of the communications network 1342, either directly or indirectly. Even though illustrated as a single element in FIG. 13, communications network 1342 may comprise other computing objects and computing devices that provide services to the system of FIG. 13, and/or may represent multiple interconnected networks, which are not shown. Each computing object 1310, 1312, etc. or computing object or devices 1320, 1322, 1324, 1326, 1328, etc. can also contain an application, such as applications 1330, 1332, 1334, 1336, 1338, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by network-enabled television 104, 200, 302, 600 for communicating with a network. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 13, as a non-limiting example, computing objects or devices 1320, 1322, 1324, 1326, 1328, etc. can be thought of as clients and computing objects 1310, 1312, etc. can be thought of as servers where computing objects 1310, 1312, etc., acting as servers provide data services, such as receiving data from client computing objects or devices 1320, 1322, 1324, 1326, 1328, etc., storing of data, processing of data, transmitting data to client computing objects or devices 1320, 1322, 1324, 1326, 1328, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1342 or bus is the Internet, for example, the computing objects 1310, 1312, etc. can be Web servers with which other computing objects or devices 1320, 1322, 1324, 1326, 1328, etc. communicate via any of a number of known protocols, such as the hypertext transfer protocol (HTTP). Computing objects 1310, 1312, etc. acting as servers may also serve as clients, e.g., computing objects or devices 1320, 1322, 1324, 1326, 1328, etc., as may be characteristic of a distributed computing environment.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system that facilitates single sign on registration for online content or services, comprising:
a memory storing computer-executable components;
a processor communicatively connected to the memory and configured to facilitate execution of at least one of the computer-executable components, the computer-executable components comprising:
an account management component configured to acquire a set of data associated with a user of a network-enabled display device and a set of application services;
a registration component configured to communicate via the network-enabled display device with a set of registration servers associated with the set of online services and identify subsets of user data requested for registering the user with at least a subset of the set of application services;
a compilation component configured to acquire the identified subsets of user data at least in part from the set of data associated with the user; and
a validation component configured to store information pertaining to the user as a secure data certificate, and provide the secure data certificate to at least one of the subset of the set of registration servers in response to a validation request.

2. The system of claim 1, the computer-executable components further comprising an activation component configured to trigger single sign on (SSO) registration to the set of application services in response to satisfaction of a condition related to an activity at the network-enabled display device, wherein the activation component is further configured to monitor the network-enabled display device for occurrence of the activity and trigger the registration component to initiate the communication in response to the satisfaction of the condition.

3. The system of claim 1, wherein the compilation component is further configured to generate a set of data fields and an associated set of labels that specify respective subsets of information; and output the set of data fields for receipt of user data entry from at least one of:
a display screen of the network-enabled display device;
a computing device connected to the data network; or
a network communication account registered to the user.

4. The system of claim 1, the computer-executable components further comprising a stored user profile related to the user of the network-enabled display device, wherein the set of application services are identified by user selection or user input and stored in conjunction with the user profile.

5. The system of claim 1, wherein the account management component is further configured to employ the data network to search for network addresses of at least one of the set of registration servers in response to receipt of a user selection of the set of application services.

6. The system of claim 1, the computer-executable components further comprising a results component configured to receive registration results from one or more of the set of registration servers and save successfully registered application services in conjunction with the user profile.

7. The system of claim 1, wherein the account management component is further configured to auto-generate login credentials for a set of accounts created for the user in response to successful registration for the subset of the set of application services, and store respective login credentials in a data store.

8. The system of claim 7, wherein the account management component is further configured to retrieve one of the respective login credentials from the data store and log into a user account associated with one of the set of application services, in response to activation of an application for accessing the one of the set of application services, and facilitate the application to acquire content from the one of the set of application services.

9. The system of claim 1, the computer-executable components further comprising a digital rights management (DRM) component configured to decode the validation request or registration results transmitted by one or more of the set of registration servers in accordance with a DRM protocol.

10. The system of claim 9, wherein the DRM component is configured to determine whether the network-enabled display device complies with the DRM protocol, and provides a request for DRM encoding to the set of registration servers in response to the network-enabled display device complying with the DRM protocol.

11. The system of claim 1, the computer-executable components further comprising a video identification component configured to output a video identification code for display at the network-enabled display device to facilitate user login to a user profile associated with the user.

12. The system of claim 11, wherein the user login to the user profile triggers single sign on (SSO) registration by the system.

13. The system of claim 1, wherein the validation component is configured to acquire at least a name, and a birth date for the user as part of the information pertaining to the user stored as the secure data certificate.

14. The system of claim 13, wherein the secure data certificate facilitates validation of an age of the user in conjunction with age-related content or service restrictions.

15. The system of claim 1, wherein:
the registration component is further configured to receive a third-party authentication request from at least one of the set of registration servers; and
the validation component is further configured to obtain user data satisfying the third-party authentication request and submit the user data in response to the third-party authentication request.

16. The system of claim 15, wherein the user data satisfying the third-party authentication request comprises:
a set of user login credentials associated with an online content or service account maintained by a third-party server; or
a set of code data matching a video identification code generated by the third-party server or generated by the system.

17. The system of claim 16, wherein the third-party server is a network server associated with an online social networking service, an online email service, a mobile network user account, or a webpage messaging account.

18. The system of claim 1, wherein the secure data certificate is stored on a removable data storage device that can be physically connected to and removed from the system, wherein the system is activated in response to physically connecting the removable data storage device to the system.

19. The system of claim 18, the computer-executable components further comprising a data store that saves a copy of the secure data certificate and stored login credentials associated with the user, wherein entry of the stored login credentials at the network-enabled display device facilitates creation of a supplemental secure data certificate for activation of the system in lieu of physically connecting the removable data storage device to the system.

20. The system of claim 1, wherein the memory, the processor and the at least one of the computer-executable components are incorporated within an operating system of the network-enabled display device, or within an operating system of a modem device employed by the network-enabled display device for electronic communication over the data network.

21. A method of providing single sign on (SSO) registration for online services, comprising:
initiating, by a system including at least one processor, a single sign on (SSO) registration application at a media playback device;
receiving, by the system, user login credentials;
employing, by the system, the user login credentials to create a SSO registration account and a secure digital certificate for a user;
receiving, by the system, a set of online service applications and linking the set of online service applications to the SSO registration account;
initiating, by the system, online registration to the set of online service applications in response to a successful login to the SSO registration account; and
submitting, by the system, the secure digital certificate to facilitate validating the user in conjunction with creation of a set of respective user accounts for respective ones of the set of online service applications.

22. The method of claim 21, further comprising storing, by the system, respective login credentials for the respective user accounts.

23. The method of claim 22, wherein storing respective login credentials further comprises storing the login credentials at a remote storage device maintained by an online media content service provider.

24. The method of claim 22, further comprising identifying, by the system, activation of a client application at the media playback device for accessing content or services from one of the set of online service applications.

25. The method of claim 23, further comprising accessing, by the system, stored login credentials for the one of the set of online service applications and submitting the stored login credentials to facilitate logging the user into an associated one of the respective user accounts pertaining to the client application.

26. The method of claim 21, further comprising outputting, by the system, a list of security settings in conjunction with creating the SSO registration account and establishing a login procedure to the SSO registration account consistent with a selected one of the list of security settings.

27. The method of claim 21, further comprising obtaining, by the system, data indicative of an age of the user and storing the data indicative of the age with the secure digital certificate for facilitating validating an age of the user for age-related content or service restrictions of the set of online service applications.

28. The method of claim 21, further comprising generating, by the system, a video identification code in response to receiving the user login credentials, and displaying the video identification code at a display screen of the media playback device.

29. The method of claim 28, wherein initiating, by the system, the online registration is further in response to receiving a user input matching the video identification code.

30. A system that provides single sign on (SSO) registration for online applications at a media playback device, comprising:
means for establishing a SSO registration account for a user of the media playback device;
means for providing a remote login procedure to the SSO registration account from a pre-designated communication platform;
means for linking a communication account or communication device associated with the pre-designated communication platform to the SSO registration account for validating the remote login;
means for receiving a request for remote login to the SSO registration account that includes information identifying a communication device or communication account from which the request is transmitted, and validating the information identifying the communication device or communication account with the linked communication account or communication device; and
means for initiating SSO registration to a predetermined set of online service applications saved for the SSO registration account in response to successful validation of the communication account or communication device.

31. The system of claim 30, further comprising means for generating a digital certificate comprising information associated with the user, and submitting the digital certificate for user validation in response to a validation query associated with the SSO registration.

32. The system of claim 31, further comprising means for storing the digital certificate on a removable data storage device, and means for identifying connection of the digital storage device to the system.

33. The system of claim 32, further comprising:
means for storing a copy of the digital certificate on a secure data store;
means for generating alternate access credentials for the user; and
means for initiating an alternate validation application that requests input of the alternate access credentials, matches an input to the alternate access credentials, and submits the stored digital certificate for user validation in response to the validation query in lieu of connection of the digital storage device to the system.
